(19) United States
(12) Patent Application Publication
(10) Pub. No.: US 2026/0371157 A1
(43) Pub. Date: Nov. 19, 2026

(54) METHOD AND APPARATUS OF TRIGGERING AND CANCELLING DELAY AWARE BUFFER STATUS

(71) Applicant: Samsung Electronics Co., Ltd., Suwon-si, Gyeonggi-do (KR)

(72) Inventors: Anil AGIWAL, Suwon-si (KR); Sangkyu BAEK, Suwon-si (KR); Weiping SUN, Suwon-si (KR)

(21) Appl. No.: 19/147,977

(22) PCT Filed: Jan. 12, 2024
(86) PCT No.: PCT/KR2024/000580

§ 371 Date: Jul. 14, 2025

(30) Foreign Application Priority Data
Jan. 13, 2023 (KR) 10-2023-0005175
Jan. 13, 2023 (KR) 10-2023-0005630

(51) Int. Cl. H04W 28/02

(52) U.S. Cl. CPC H04W 28/0278

(57) ABSTRACT

The disclosure relates to a 5G or 6G communication system for supporting a higher data transmission rate. A method 2024/151118 performed by a user equipment (UE) in a communication system includes receiving, from a base station, a radio resource control (RRC) message including configuration information on reporting of delay information associated with buffered data; identifying that the reporting of delay information is triggered based on the configuration information; and transmitting, to the base station, a medium access control (MAC) control element (CE) for the reporting of delay information in case that the reporting of delay information is pending.

### BACKGROUND ART

5G mobile communication technologies define broad frequency bands such that high transmission rates and new services are possible, and can be implemented not only in “Sub 6GHz” bands such as 3.5GHz, but also in “Above 6GHz” bands referred to as mm Wave including 28GHz and 39GHz. In addition, it has been considered to implement 6G mobile communication technologies (referred to as Beyond 5G systems) in terahertz bands (for example, 95GHz to 3THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is un-available, and positioning.

Moreover, there has been ongoing standardization in air interface architecture/ protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

The above information is presented as background information only to assist with an understanding of the disclosure. No determination has been made, and no assertion is made, as to whether any of the above might be applicable as prior art with regard to the disclosure.

### DISCLOSURE OF INVENTION

### Technical Problem

The disclosure may provide a method and an apparatus for triggering delay aware buffer status.

The disclosure may provide a method and an apparatus for cancelling delay aware buffer status.

The technical objects to be achieved by various embodiments of the disclosure are not limited to the technical objects mentioned above, and other technical objects not mentioned may be considered by those skilled in the art from various embodiments of the disclosure to be described below.

### Solution to Problem

According to an embodiment, a method performed by a user equipment (UE) in a communication system is provided.

According to an embodiment, the method includes: receiving, from a base station, a radio resource control (RRC) message including configuration information on reporting of delay information associated with buffered data; identifying that the reporting of delay information is triggered based on the configuration information; and transmitting, to the base station, a medium access control (MAC) control element (CE) for the reporting of delay information in case that the reporting of delay information is pending.

According to an embodiment, in case that the reporting of delay information is triggered, the reporting of delay information is identified as pending until the reporting of delay information is cancelled.

According to an embodiment, the reporting of delay information is triggered in case that a remaining time associated with the buffered data is lower than a threshold included in the configuration information.

According to an embodiment, the MAC CE for the reporting of delay information includes information on the remaining time.

According to an embodiment, the method includes transmitting, to the base station, capability information including an indication whether the UE supports the reporting of delay information.

According to an embodiment, the reporting of delay information is cancelled in case that all buffered data is transmitted.

According to an embodiment, the reporting of delay information is cancelled in case that the MAC CE is transmitted and the MAC CE includes delay information associated with all buffered data.

According to an embodiment, the buffered data is buffered for a logical channel group (LCG).

According to an embodiment, a user equipment (UE) in a communication system is provided.

According to an embodiment, the UE includes a transceiver and a processor coupled with the transceiver and configured to: receive, from a base station, a radio resource control (RRC) message including configuration information on reporting of delay information associated with buffered data; identify that the reporting of delay information is triggered based on the configuration information; and transmit, to the base station, a medium access control (MAC) control element (CE) for the reporting of delay information in case that the reporting of delay information is pending.

According to an embodiment, in case that the reporting of delay information is triggered, the reporting of delay information is identified as pending until the reporting of delay information is cancelled.

According to an embodiment, the reporting of delay information is triggered in case that a remaining time associated with the buffered data is lower than a threshold included in the configuration information.

According to an embodiment, the MAC CE for the reporting of delay information includes information on the remaining time.

According to an embodiment, the processor is further configured to transmit, to the base station, capability information including an indication whether the UE supports the reporting of delay information.

According to an embodiment, the reporting of delay information is cancelled in case that all buffered data is transmitted.

According to an embodiment, the reporting of delay information is cancelled in case that the MAC CE is transmitted and the MAC CE includes delay information associated with all buffered data.

According to an embodiment, a method performed by a base station in a communication system is provided.

According to an embodiment, the method includes: transmitting, to a user equipment (UE), a radio resource control (RRC) message including configuration information on reporting of delay information associated with buffered data; and receiving, from the UE, a medium access control (MAC) control element (CE) for the reporting of delay information in case that the reporting of delay information is pending.

According to an embodiment, in case that the reporting of delay information is triggered, the reporting of delay information is identified as pending until the reporting of delay information is cancelled.

According to an embodiment, a base station in a communication system is provided.

According to an embodiment, the base station includes a transceiver and a processor coupled with the transceiver and configured to: transmit, to a user equipment (UE), a radio resource control (RRC) message including configuration information on reporting of delay information associated with buffered data; and receive, from the UE, a medium access control (MAC) control element (CE) for the reporting of delay information in case that the reporting of delay information is pending.

According to an embodiment, in case that the reporting of delay information is triggered, the reporting of delay information is identified as pending until the reporting of delay information is cancelled.

The above-described various embodiments of the disclosure are merely some of the preferred embodiments of the disclosure, and various embodiments reflecting the technical features of the disclosure may be derived and understood by those skilled in the art based on the following detailed description of the disclosure.

### Advantageous Effects of Invention

The disclosure may provide a method and an apparatus for triggering delay aware buffer status.

The disclosure may provide a method and an apparatus for cancelling delay aware buffer status.

The effects that can be achieved through the disclosure are not limited to the effects mentioned in the various embodiments, and other effects not mentioned will be clearly understood by those skilled in the art from the description below.

### BRIEF DESCRIPTION OF DRAWINGS

The above and other aspects, features, and advantages of certain embodiments of the disclosure will be more apparent from the following description taken in conjunction with the accompanying drawings, in which:

FIG. 1 illustrates an example method performed by a UE according to an embodiment of the disclosure;

FIG. 2 illustrates an example method performed by a UE according to an embodiment of the disclosure;

FIG. 3 illustrates an example method performed by a UE according to an embodiment of the disclosure;

FIG. 4 illustrates an example method performed by a UE according to an embodiment of the disclosure;

FIG. 5 illustrates an example method performed by a UE according to an embodiment of the disclosure;

FIG. 6 illustrates an electronic device according to embodiments of the present disclosure; and

FIG. 7 illustrates a base station according to embodiments of the present disclosure.

### MODE FOR THE INVENTION

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

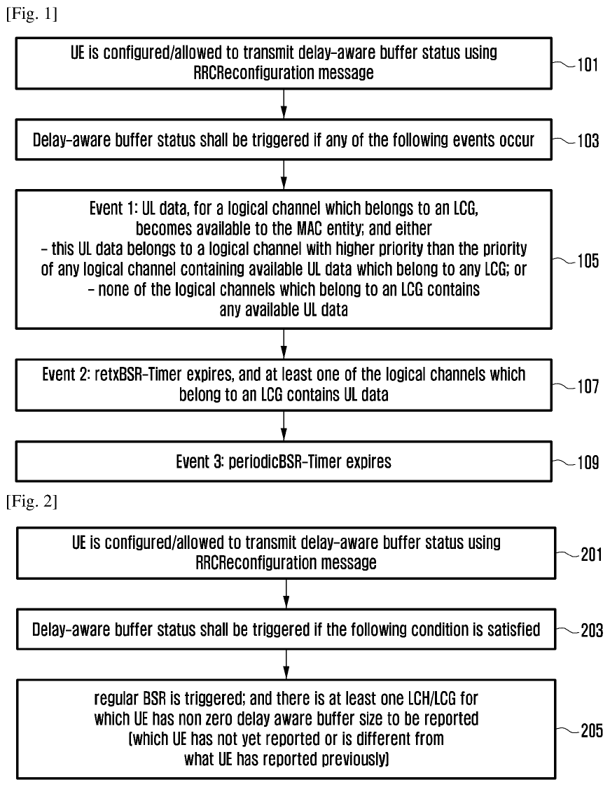

FIGS. 1 through 9, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is known to those skilled in the art that blocks of a flowchart (or sequence diagram) and a combination of flowcharts may be represented and executed by computer program instructions. These computer program instructions may be loaded on a processor of a general purpose computer, special purpose computer, or programmable data processing equipment. When the loaded program instructions are executed by the processor, they create a means for carrying out functions described in the flowchart.

Because the computer program instructions may be stored in a computer readable memory that is usable in a specialized computer or a programmable data processing equipment, it is also possible to create articles of manufacture that carry out functions described in the flowchart. Because the computer program instructions may be loaded on a computer or a programmable data processing equipment, when executed as processes, they may carry out operations of functions described in the flowchart.

A block of a flowchart may correspond to a module, a segment, or a code containing one or more executable instructions implementing one or more logical functions, or may correspond to a part thereof. In some cases, functions described by blocks may be executed in an order different from the listed order. For example, two blocks listed in sequence may be executed at the same time or executed in reverse order.

In this description, the words “unit”, “module” or the like may refer to a software component or hardware component, such as, for example, a field-programmable gate array (FPGA) or an application-specific integrated circuit (ASIC) capable of carrying out a function or an operation. However, a “unit”, or the like, is not limited to hardware or software. A unit, or the like, may be configured so as to reside in an addressable storage medium or to drive one or more processors. Units, or the like, may refer to software components, object-oriented software components, class components, task components, processes, functions, attributes, procedures, subroutines, program code segments, drivers, firmware, microcode, circuits, data, databases, data structures, tables, arrays or variables. A function provided by a component and unit may be a combination of smaller components and units, and may be combined with others to compose larger components and units. Components and units may be configured to drive a device or one or more processors in a secure multimedia card.

Prior to the detailed description, terms or definitions necessary to understand the disclosure are described. However, these terms should be construed in a non-limiting way.

The “base station (BS)” is an entity communicating with a user equipment (UE) and may be referred to as BS, base transceiver station (BTS), node B (NB), evolved NB (eNB), access point (AP), 5G NB (5gNB), or gNB.

The “UE” is an entity communicating with a BS and may be referred to as UE, device, mobile station (MS), mobile equipment (ME), or terminal.

To meet the demand for wireless data traffic having increased since deployment of fourth generation (4G) communication systems, efforts have been made to develop an improved fifth generation (5G) or pre-5G communication system. Therefore, the 5G or pre-5G communication system is also called a ‘Beyond 4G Network’ or a ‘Post long term evolution (LTE) System’. The 5G communication system is considered to be implemented in higher frequency (mmWave) bands, e.g., 60 GHz bands, so as to accomplish higher data rates. To decrease propagation loss of the radio waves and increase the transmission distance, the beamforming, massive multiple-input multiple-output (MIMO), Full Dimensional MIMO (FD-MIMO), array antenna, an analog beam forming, large scale antenna techniques are discussed in 5G communication systems. In addition, in 5G communication systems, development for system network improvement is under way based on advanced small cells, cloud Radio Access Networks (RANs), ultra-dense networks, device-to-device (D2D) communication, wireless backhaul, moving network, cooperative communication, Coordinated Multi-Points (COMP), reception-end interference cancellation and the like. In the 5G system, Hybrid frequency shift keying (FSK) and Quadrature Amplitude Modulation (QAM) Modulation (FQAM) and sliding window superposition coding (SWSC) as an advanced coding modulation (ACM), and filter bank multi carrier (FBMC), non-orthogonal multiple access (NOMA), and sparse code multiple access (SCMA) as an advanced access technology have been developed.

The Internet, which is a human centered connectivity network where humans generate and consume information, is now evolving to the Internet of Things (IOT) where distributed entities, such as things, exchange and process information without human intervention. The Internet of Everything (IoE), which is a combination of the IoT technology and the Big Data processing technology through connection with a cloud server, has emerged. As technology elements, such as “sensing technology”, “wired/wireless communication and network infrastructure”, “service interface technology”, and “Security technology” have been demanded for IoT implementation, a sensor network, a Machine-to-Machine (M2M) communication, Machine Type Communication (MTC), and so forth have been recently researched. Such an IoT en-vironment may provide intelligent Internet technology services that create a new value to human life by collecting and analysing data generated among connected things. IoT may be applied to a variety of fields including smart home, smart building, smart city, smart car or connected cars, smart grid, health care, smart appliances and advanced medical services through convergence and combination between existing Information Technology (IT) and various industrial applications.

In line with this, various attempts have been made to apply 5G communication systems to IoT networks. For example, technologies such as a sensor network, Machine Type Communication (MTC), and Machine-to-Machine (M2M) communication may be implemented by beamforming, MIMO, and array antennas. Application of a cloud Radio Access Network (RAN) as the above-described Big Data processing technology may also be considered to be as an example of convergence between the 5G technology and the IoT technology.

Carrier aggregation (CA)/Multi-connectivity in fifth generation wireless communication system is described. The fifth generation wireless communication system, supports standalone mode of operation as well dual connectivity (DC). In DC a multiple reception/transmission (Rx/Tx) user equipment (UE) may be configured to utilize resources provided by two different nodes (or node-Bs (NBs)) connected via non-ideal backhaul. One node acts as the Master Node (MN) and the other as the Secondary Node (SN). The MN and SN are connected via a network interface and at least the MN is connected to the core network. NR also supports Multi-RAT Dual Connectivity (MR-DC) operation whereby a UE in RRC_CONNECTED is configured to utilize radio resources provided by two distinct schedulers, located in two different nodes connected via a non-ideal backhaul and providing either Evolved Universal Terrestrial Radio Access (E-UTRA) (i.e. if the node is an next generation evolved Node-B (ng-eNB)) or NR access (i.e. if the node is a gNB).

In NR, for a UE in RRC_CONNECTED not configured with CA/DC, there is only one serving cell comprising of the primary cell. For a UE in RRC_CONNECTED configured with CA/DC, the term ‘serving cells’ is used to denote the set of cells comprising of the Special Cell(s) and all secondary cells. In NR the term Master Cell Group (MCG) refers to a group of serving cells associated with the Master Node, comprising of the primary cell (PCell) and optionally one or more secondary cells (SCells). In NR the term Secondary Cell Group (SCG) refers to a group of serving cells associated with the Secondary Node, comprising of the primary secondary cell (or primary SCG cell) (PSCell) and optionally one or more SCells. In NR PCell (primary cell) refers to a serving cell in MCG, operating on the primary frequency, in which the UE either performs the initial connection establishment procedure or initiates the connection re-establishment procedure. In NR for a UE configured with CA, SCell is a cell providing additional radio resources on top of Special Cell. PSCell refers to a serving cell in SCG in which the UE performs random access when performing the Re-configuration with Sync procedure. For Dual Connectivity operation the term Special Cell (SpCell) refers to the PCell of the MCG or the PSCell of the SCG, otherwise the term Special Cell refers to the PCell.

Random access in fifth generation wireless communication system is described. In the 5G wireless communication system, random access (RA) is supported. Random access (RA) is used to achieve uplink (UL) time synchronization. RA is used during initial access, handover, radio resource control (RRC) connection re-establishment procedure, scheduling request (SR) transmission, secondary cell group (SCG) addition/ modification, beam failure recovery and data or control information transmission in UL by a non-synchronized UE in RRC CONNECTED state. Several types of random access procedure is supported such as contention based random access, contention free random access and each of these can be one of 2 step random access or 4 step random access.

Bandwidth part (BWP) operation in fifth generation wireless communication system is described. In fifth generation wireless communication system, bandwidth adaptation (BA) is supported. With BA, the receive and transmit bandwidth of a UE need not be as large as the bandwidth of the cell and can be adjusted: the width can be ordered to change (e.g. to shrink during period of low activity to save power); the location can be moved in the frequency domain (e.g. to increase scheduling flexibility); and the subcarrier spacing can be ordered to change (e.g. to allow different services). A subset of the total cell bandwidth of a cell is referred to as a Bandwidth Part (BWP). BA is achieved by configuring a RRC connected UE with BWP(s) and telling the UE which of the configured BWPs is currently the active one. When BA is configured, the UE only has to monitor physical downlink control channel (PDCCH) on the one active BWP i.e. it does not have to monitor PDCCH on the entire downlink (DL) frequency of the serving cell.

In RRC connected state, a UE is configured with one or more DL and UL BWPs, for each configured Serving Cell (i.e. PCell or SCell). For an activated Serving Cell, there is always one active UL and DL BWP at any point in time. The BWP switching for a Serving Cell is used to activate an inactive BWP and deactivate an active BWP at a time. The BWP switching is controlled by the PDCCH indicating a downlink assignment or an uplink grant, by the bwp-InactivityTimer, by RRC signaling, or by the MAC entity itself upon initiation of Random Access procedure. Upon addition of SpCell or activation of an SCell, at least one of the DL BWP indicated by firstActive-DownlinkBWP-Id and the UL BWP indicated by firstActiveUplinkBWP-Id is active without receiving PDCCH indicating a downlink assignment or an uplink grant. The active BWP for a Serving Cell is indicated by either RRC or PDCCH. For unpaired spectrum, a DL BWP is paired with a UL BWP, and BWP switching is common for both UL and DL. Upon expiry of BWP inactivity timer, the UE switch to the active DL BWP to the default DL BWP or initial DL BWP (if default DL BWP is not configured).

RRC states in fifth generation wireless communication system is described. In the fifth generation wireless communication system, RRC can be in one of the following states: RRC_IDLE, RRC_INACTIVE, and RRC_CONNECTED. A UE is either in RRC_CONNECTED state or in RRC_INACTIVE state when an RRC connection has been established. If this is not the case, i.e. no RRC connection is established, the UE is in RRC_IDLE state. The RRC states can further be characterized as follows:

In the RRC_IDLE, a UE specific discontinuous reception (DRX) may be configured by upper layers; The UE monitors Short Messages transmitted with paging radio network temporary identifier (RNTI) (P-RNTI) over downlink control information (DCI); monitors a Paging channel for core network (CN) paging using 5G-S-temoprary mobile subscriber identity (5G-S-TMSI); performs neighboring cell measurements and cell (re-)selection; acquires system information (SI) and can send SI request (if configured); performs logging of available measurements together with location and time for logged measurement configured UEs.

In RRC_INACTIVE, a UE specific DRX may be configured by upper layers or by RRC layer; UE stores a UE Inactive Access-Stratum (AS) context; a RAN-based notification area is configured by RRC layer. The UE monitors Short Messages transmitted with P-RNTI over DCI; monitors a Paging channel for CN paging using 5G-S-TMSI and RAN paging using full inactive-RNTI (I-RNTI); performs neighbouring cell measurements and cell (re-)selection; performs RAN-based notification area updates peri-odically and when moving outside the configured RAN-based notification area; acquires system information and can send SI request (if configured); performs logging of available measurements together with location and time for logged measurement configured UEs.

In the RRC_CONNECTED, the UE stores the AS context and transfer of unicast data to/from UE takes place; The UE monitors Short Messages transmitted with P-RNTI over DCI, if configured; monitors control channels associated with the shared data channel to determine if data is scheduled for it; provides channel quality and feedback information; performs neighbouring cell measurements and measurement reporting; acquires system information.

Physical downlink control channel (PDCCH) in fifth generation wireless communication system is described. In the fifth generation wireless communication system, PDCCH is used to schedule DL transmissions on physical downlink shared channel (PDSCH) and UL transmissions on physical uplink shared channel (PUSCH), where the Downlink Control Information (DCI) on PDCCH includes at least one of: Downlink assignments containing at least modulation and coding format, resource allocation, and hybrid-automatic repeat request (HARQ or hybrid-ARQ) information related to downlink shared channel (DL-SCH); Uplink scheduling grants containing at least modulation and coding format, resource allocation, and hybrid-ARQ information related to uplink shared channel (UL-SCH). In addition to scheduling, PDCCH can be used to for at least one of: Activation and deactivation of configured PUSCH transmission with configured grant; Activation and deactivation of PDSCH semi-persistent transmission; Notifying one or more UEs of the slot format; Notifying one or more UEs of the physical resource block(s) (PRB(s)) and orthogonal frequency division multiplexing (OFDM) symbol(s) where the UE may assume no transmission is intended for the UE; Transmission of transmit power control (TPC) commands for physical uplink control channel (PUCCH) and PUSCH; Transmission of one or more TPC commands for sounding reference signal (SRS) transmissions by one or more UEs; Switching a UE's active bandwidth part; Initiating a random access procedure.

A UE monitors a set of PDCCH candidates in the configured monitoring occasions in one or more configured COntrol REsource SETs (CORESETs) according to the corresponding search space configurations. A CORESET consists of a set of PRBs with a time duration of 1 to 3 OFDM symbols. The resource units Resource Element Groups (REGs) and Control Channel Elements (CCEs) are defined within a CORESET with each CCE consisting a set of REGs. Control channels are formed by aggregation of CCE. Different code rates for the control channels are realized by aggregating different number of CCE. Interleaved and non-interleaved CCE-to-REG mapping are supported in a CORESET. Polar coding is used for PDCCH. Each resource element group carrying PDCCH carries its own demodulation reference signal (DMRS). Quadrature Phase Shift Keying (QPSK) modulation is used for PDCCH.

In fifth generation wireless communication system, a list of search space configurations is signaled by gNB for each configured BWP of serving cell wherein each search space configuration is uniquely identified by a search space identifier. Search space identifier is unique amongst the BWPs of a serving cell. Identifier of search space configuration to be used for specific purpose such as paging reception, SI reception, random access response reception is explicitly signaled by gNB for each configured BWP. In NR search space configuration comprises of parameters Monitoring-periodicity-PDCCH-slot, Monitoring-offset-PDCCH-slot, Monitoring-symbols-PDCCH-within-slot and duration. A UE determines PDCCH monitoring occasion(s) within a slot using the parameters PDCCH monitoring periodicity (Monitoring-periodicity-PDCCH-slot), the PDCCH monitoring offset (Monitoring-offset-PDCCH-slot), and the PDCCH monitoring pattern (Monitoring-symbols-PDCCH-within-slot). PDCCH monitoring occasions are there in slots ‘x’ to x+duration where the slot with number ‘x’ in a radio frame with number ‘y’ satisfies the equation below:

(y*(number of slots in a radio frame)+x-Monitoring-offset-PDCCH-slot) mod (Monitoring-periodicity-PDCCH-slot)=0;

The starting symbol of a PDCCH monitoring occasion in each slot having PDCCH monitoring occasion is given by Monitoring-symbols-PDCCH-within-slot. The length (in symbols) of a PDCCH monitoring occasion is given in the CORESET associated with the search space. Search space configuration includes the identifier of CORESET configuration associated with it. A list of CORESET configurations is signaled by gNB for each configured BWP of serving cell wherein each coreset configuration is uniquely identified by an coreset identifier. CORESET identifier is unique amongst the BWPs of a serving cell. Note that each radio frame is of 10 ms duration. Radio frame is identified by a radio frame number or system frame number. Each radio frame comprises of several slots wherein the number of slots in a radio frame and duration of slots depends on sub carrier spacing (SCS). The number of slots in a radio frame and duration of slots depends on radio frame for each supported SCS is pre-defined in NR.

Each CORESET configuration is associated with a list of Transmission configuration indicator (TCI) states. One downlink reference signal (DL RS) identifier (ID) (synchronization signal block (SSB) or channel state information reference signal (CSI RS)) is configured per TCI state. The list of TCI states corresponding to a CORESET configuration is signaled by gNB via RRC signaling. One of the TCI state in TCI state list is activated and indicated to UE by gNB. TCI state indicates the DL TX beam (DL TX beam is quasi co-located (QCLed) with SSB/CSI RS of TCI state) used by gNB for transmission of PDCCH in the PDCCH monitoring occasions of a search space.

Downlink scheduling in fifth generation wireless communication system is described. In the downlink, the gNB can dynamically allocate resources to UEs via the cell-RNTI (C-RNTI) on PDCCH(s). A UE always monitors the PDCCH(s) in order to find possible assignments when its downlink reception is enabled (activity governed by DRX when configured). When CA is configured, the same C-RNTI applies to all serving cells.

The gNB may pre-empt an ongoing PDSCH transmission to one UE with a latency-critical transmission to another UE. The gNB can configure UEs to monitor interrupted transmission indications using interruption-RNTI (INT-RNTI) on a PDCCH. If a UE receives the interrupted transmission indication, the UE may assume that no useful information to that the UE was carried by the resource elements included in the indication, even if some of those resource elements were already scheduled to this UE.

In addition, with Semi-Persistent Scheduling (SPS), the gNB can allocate downlink resources for the initial HARQ transmissions to UEs: RRC defines the periodicity of the configured downlink assignments while PDCCH addressed to configured scheduling-RNTI (CS-RNTI) can either signal and activate the configured downlink assignment, or deactivate it; i.e. a PDCCH addressed to CS-RNTI indicates that the downlink assignment can be implicitly reused according to the periodicity defined by RRC, until deactivated. When required, retransmissions are explicitly scheduled on PDCCH(s).

The dynamically allocated downlink reception overrides the configured downlink assignment in the same serving cell, if they overlap in time. Otherwise, a downlink reception according to the configured downlink assignment is assumed, if activated.

The UE may be configured with up to 8 active configured downlink assignments for a given BWP of a serving cell. When more than one is configured:
The network decides which of these configured downlink assignments are active at a time (including all of them); and
Each configured downlink assignment is activated separately using a DCI command and deactivation of configured downlink assignments is done using a DCI command, which can either deactivate a single configured downlink assignment or multiple configured downlink assignments jointly.

Uplink scheduling in fifth generation wireless communication system is described. In the uplink, the gNB can dynamically allocate resources to UEs via the C-RNTI on PDCCH(s). A UE always monitors the PDCCH(s) in order to find possible grants for uplink transmission when its downlink reception is enabled (activity governed by DRX when configured). When CA is configured, the same C-RNTI applies to all serving cells.

The gNB may cancel a PUSCH transmission, or a repetition of a PUSCH transmission, or an SRS transmission of a UE for another UE with a latency-critical transmission. The gNB can configure UEs to monitor cancelled transmission indications using cancellation indication-RNTI (CI-RNTI) on a PDCCH. If a UE receives the cancelled transmission indication, the UE shall cancel the PUSCH transmission from the earliest symbol overlapped with the resource or the SRS transmission overlapped with the resource indicated by cancellation. In addition, with Configured Grants, the gNB can allocate uplink resources for the initial HARQ transmissions and HARQ retransmissions to UEs. Two types of configured uplink grants are defined:

With Type 1, RRC directly provides the configured uplink grant (including the pe-riodicity).

With Type 2, RRC defines the periodicity of the configured uplink grant while PDCCH addressed to CS-RNTI can either signal and activate the configured uplink grant, or deactivate it; i.e. a PDCCH addressed to CS-RNTI indicates that the uplink grant can be implicitly reused according to the periodicity defined by RRC, until deactivated.

If the UE is not configured with enhanced intra-UE overlapping resources prioritization, the dynamically allocated uplink transmission overrides the configured uplink grant in the same serving cell, if they overlap in time. Otherwise, an uplink transmission according to the configured uplink grant is assumed, if activated.

If the UE is configured with enhanced intra-UE overlapping resources prioritization, in case a configured uplink grant transmission overlaps in time with dynamically allocated uplink transmission or with another configured uplink grant transmission in the same serving cell, the UE prioritizes the transmission based on the comparison between the highest priority of the logical channels that have data to be transmitted and which are multiplexed or can be multiplexed in medium access control (MAC) protocol data units (PDUs) associated with the overlapping resources. Similarly, in case a configured uplink grant transmissions or a dynamically allocated uplink transmission overlaps in time with a scheduling request transmission, the UE prioritizes the transmission based on the comparison between the priority of the logical channel which triggered the scheduling request and the highest priority of the logical channels that have data to be transmitted and which are multiplexed or can be multiplexed in MAC PDU associated with the overlapping resource. In case the MAC PDU associated with a deprioritized transmission has already been generated, the UE keeps it stored to allow the gNB to schedule a retransmission. The UE may also be configured by the gNB to transmit the stored MAC PDU as a new transmission using a subsequent resource of the same configured uplink grant configuration when an explicit retransmission grant is not provided by the gNB.

Retransmissions other than repetitions are explicitly allocated via PDCCH(s) or via configuration of a retransmission timer.

The UE may be configured with up to 12 active configured uplink grants for a given BWP of a serving cell. When more than one is configured, the network decides which of these configured uplink grants are active at a time (including all of them). Each configured uplink grant can either be of Type 1 or Type 2. For Type 2, activation and deactivation of configured uplink grants are independent among the serving cells. When more than one Type 2 configured grant is configured, each configured grant is activated separately using a DCI command and deactivation of Type 2 configured grants is done using a DCI command, which can either deactivate a single configured grant configuration or multiple configured grant configurations jointly.

When supplementary uplink (SUL) is configured, the network should ensure that an active configured uplink grant on SUL does not overlap in time with another active configured uplink grant on the other UL configuration.

For both dynamic grant and configured grant, for a transport block, two or more repetitions can be in one slot, or across slot boundary in consecutive available slots with each repetition in one slot. For both dynamic grant and configured grant Type 2, the number of repetitions can be also dynamically indicated in the layer 1(L1) signaling. The dynamically indicated number of repetitions shall override the RRC configured number of repetitions, if both are present.

Discontinuous Reception (DRX) in fifth generation wireless communication system is described. In 5G wireless communication system, the PDCCH monitoring activity of the UE in RRC connected mode is governed by DRX, BA and DCI with cyclic re-dundancy check (CRC) scrambled by power saving-RNTI (PS-RNTI) (DCP). When DRX is configured, the UE does not have to continuously monitor PDCCH. DRX is characterized by the following:
on-duration: duration that the UE waits for, after waking up, to receive PDCCHs. If the UE successfully decodes a PDCCH, the UE stays awake and starts the inactivity timer;
inactivity-timer: duration that the UE waits to successfully decode a PDCCH, from the last successful decoding of a PDCCH, failing which it can go back to sleep. The UE shall restart the inactivity timer following a single successful decoding of a PDCCH for a first transmission only (i.e. not for retransmissions);
retransmission-timer: duration until a retransmission can be expected; cycle: specifies the periodic repetition of the on-duration followed by a possible period of inactivity;
active-time: total duration that the UE monitors PDCCH. This includes the “on-duration” of the DRX cycle, the time when the UE is performing continuous reception while the inactivity timer has not expired, and the time when the UE is performing continuous reception while waiting for a retransmission opportunity.

Logical channel prioritization (LCP) in fifth generation wireless communication system is described. In NR, the UE has an uplink rate control function which manages the sharing of uplink resources between logical channels. RRC controls the uplink rate control function by giving each logical channel a priority, a prioritized bit rate (PBR), and a buffer size duration (BSD). In addition, mapping restrictions can be configured. With LCP restrictions in MAC, RRC can restrict the mapping of a logical channel to a subset of the configured cells, numerologies, PUSCH transmission durations, configured grant configurations and control whether a logical channel can utilise the resources allocated by a Type 1 Configured Grant or whether a logical channel can utilise dynamic grants indicating a certain physical priority level. With such restrictions, it then becomes possible to reserve, for instance, the numerology with the largest subcarrier spacing and/or shortest PUSCH transmission duration for Ultra-Reliable and Low Latency Communications (URLLC) services. Furthermore, RRC can associate logical channels with different SR configurations, for instance, to provide more frequent SR opportunities to URLLC services. The uplink rate control function ensures that the UE serves the logical channel(s) in the following sequence:
1. All relevant logical channels in decreasing priority order up to their PBR;
2. All relevant logical channels in decreasing priority order for the remaining resources assigned by the grant.

In case the PBRs are all set to zero, the first step is skipped and the logical channels are served in strict priority order: the UE maximizes the transmission of higher priority data.

The mapping restrictions tell the UE which logical channels are relevant for the grant received. If no mapping restrictions are configured, all logical channels are considered.

If more than one logical channel has the same priority, the UE shall serve them equally.

Buffer Status Reporting (BSR) in fifth generation wireless communication system is described. In NR, BSR procedure is used to provide the serving gNB with information about UL data volume in the MAC entity. RRC configures the following parameters to control the BSR:
periodicBSR-Timer;
retxBSR-Timer;
logicalChannelSR-DelayTimerApplied;
logicalChannelSR-DelayTimer;
logicalChannelSR-Mask;
logicalChannelGroup.

Each logical channel may be allocated to a logical channel group (LCG) using the logicalChannelGroup. The maximum number of LCGs is eight. A BSR shall be triggered if any of the following events occur:
UL data, for a logical channel which belongs to an LCG, becomes available to the MAC entity; and either
this UL data belongs to a logical channel with higher priority than the priority of any logical channel containing available UL data which belong to any LCG; or
none of the logical channels which belong to an LCG contains any available UL data.

in which case the BSR is referred below to as ‘Regular BSR’;
UL resources are allocated and number of padding bits is equal to or larger than the size of the Buffer Status Report medium access control (MAC) control element (CE) plus its subheader, in which case the BSR is referred below to as ‘Padding BSR’;
retxBSR-Timer (i.e. retransmission timer for BSRs) expires, and at least one of the logical channels which belong to an LCG contains UL data, in which case the BSR is referred below to as ‘Regular BSR’;
periodicBSR-Timer (timer controls how frequently the UE sends a Periodic BSR) expires, in which case the BSR is referred below to as ‘Periodic BSR’.

For Regular BSR, the MAC entity shall:
1>if the BSR is triggered for a logical channel for which logicalChannelSR-DelayTimerApplied with value true is configured by upper layers:
   2>start or restart the logicalChannelSR-DelayTimer.
1>else:
   2>if running, stop the logicalChannelSR-DelayTimer.

For Regular and Periodic BSR, the MAC entity shall:
1>if more than one LCG has data available for transmission when the MAC PDU containing the BSR is to be built:
   2>report Long BSR for all LCGs which have data available for transmission.
1>else:
   2>report Short BSR.

For Padding BSR, the MAC entity shall:
1>if the number of padding bits is equal to or larger than the size of the Short BSR plus its subheader but smaller than the size of the Long BSR plus its subheader:
   2>if more than one LCG has data available for transmission when the BSR is to be built:
      3>if the number of padding bits is equal to the size of the Short BSR plus its subheader:
         4>report Short Truncated BSR of the LCG with the highest priority logical channel with data available for transmission.
      3>else:
         4>report Long Truncated BSR of the LCG(s) with the logical channels having data available for transmission following a decreasing order of the highest priority logical channel (with or without data available for transmission) in each of these LCG(s), and in case of equal priority, in increasing order of LCG ID.
   2>else:
      3>report Short BSR.
1>else if the number of padding bits is equal to or larger than the size of the Long BSR plus its subheader:
   2>report Long BSR for all LCGs which have data available for transmission.

For BSR triggered by retxBSR-Timer expiry, the MAC entity considers that the logical channel that triggered the BSR is the highest priority logical channel that has data available for transmission at the time the BSR is triggered.

The MAC entity shall:
1>if the Buffer Status reporting procedure determines that at least one BSR has been triggered and not cancelled:
   2>if UL-SCH resources are available for a new transmission and the UL-SCH resources can accommodate the BSR MAC CE plus its subheader as a result of logical channel prioritization:
      3>instruct the Multiplexing and Assembly procedure to generate the BSR MAC CE(s);
      3>start or restart periodicBSR-Timer except when all the generated BSRs are long or short Truncated BSRs;
      3>start or restart retxBSR-Timer.
   2>if a Regular BSR has been triggered and logicalChannelSR-DelayTimer is not running:
      3>if there is no UL-SCH resource available for a new transmission; or
      3>if the MAC entity is configured with configured uplink grant(s) and the Regular BSR was triggered for a logical channel for which logicalChannelSR-Mask is set to false; or
      3>if the UL-SCH resources available for a new transmission do not meet the LCP mapping restrictions configured for the logical channel that triggered the BSR:
         4>trigger a Scheduling Request.

A MAC PDU shall contain at most one BSR MAC CE, even when multiple events have triggered a BSR. The Regular BSR and the Periodic BSR shall have precedence over the padding BSR.

The MAC entity shall restart retxBSR-Timer upon reception of a grant for transmission of new data on any UL-SCH.

All triggered BSRs may be cancelled when the UL grant(s) can accommodate all pending data available for transmission but is not sufficient to additionally accommodate the BSR MAC CE plus its subheader. All BSRs triggered prior to MAC PDU assembly shall be cancelled when a MAC PDU is transmitted and this PDU includes a Long or Short BSR MAC CE which contains buffer status up to (and including) the last event that triggered a BSR prior to the MAC PDU assembly.

Embodiments of the disclosure will be described in detail with reference to the accompanying drawings. A base station refers to an entity that allocates resources to a terminal, and may be at least one of a gNode B, a gNB, an eNode B, a node B, a base station (BS), a radio access unit, a base station controller, or a node on a network. A terminal may include user equipment (UE), a mobile station (MS), a cellular phone, a smart phone, a computer, or a multimedia system capable of performing a communication function. Although embodiments of the disclosure will be described with reference to a 5G system as an example, embodiments of the disclosure are also applicable to other communication systems having similar technical backgrounds or channel types. For example, mobile communication technologies developed after 5G may be included therein. Therefore, embodiments of the disclosure are also applicable to other communication systems through a partial modification without substantially deviating from the scope of the disclosure as deemed by those skilled in the art. The embodiments of the disclosure described hereinafter may be applied simultaneously or in combination.

Extended reality (XR) is a term for different types of realities and refers to all real-and-virtual combined environments and human-machine interactions generated by computer technology and wearables. The XR includes following representative forms and the areas interpolated among them: Augmented Reality (AR); Mixed Reality (MR); Virtual Reality (VR). In order to enhance the scheduling of uplink resources for XR, the following improvements are envisioned:
One or more additional buffer status (BS) table(s) to reduce the quantisation errors in BSR reporting (e.g. for high bit rates);
Delay knowledge of buffered data, consisting of e.g. remaining time, and distinguishing how much data is buffered for which delay. Data volume information associated with delay information e.g. remaining time is introduced. Data volume information associated with delay information may correspond to Delay-aware buffer status discussed below. It is to be determined whether the delay information is reported as part of BSR or as a new MAC CE. Also, how the delay information can be up-to-date considering e.g. scheduling and transmission delays needs to be investigated further.
Additional BSR triggering conditions to allow timely availability of buffer status information may be investigated further

A new buffer status MAC CE or existing MAC CE may be defined to report remaining delivery time. This MAC CE may include at least one of the followings:
logical channel (LCH) identifier (ID), shortest remaining delivery time amongst all the frames in the buffer of this LCH
LCG ID, shortest remaining delivery time amongst all the frames in the buffer of LCHs of this LCG
amount/size of data that should be delivered within the remaining delivery time may also be added
Only reports the amount of data that fulfills 1) upper bound and/or 2) lower bound of remaining time if configured. It means that there is data whose remaining time is lower than a threshold. In other words, if the remaining time is lower/higher than a threshold, delay-aware buffer status is triggered.

One of the issue for XR is for UE to determine when MAC entity/UE initiate transmission of the delay-aware buffer status MAC CE i.e. MAC CE which includes delay knowledge of buffered data e.g. remaining time and distinguishing how much data is buffered for which delay.

### Method 1

According to an embodiment of the disclosure, a UE is configured/allowed to transmit delay-aware buffer status by gNB using RRCReconfiguration message (i.e. higher layer signaling). The UE may indicate its capability to support delay aware buffer status to gNB using UE capability information message. FIG. 1 illustrates an example method performed by a UE according to an embodiment of the disclosure. FIG. 1 illustrates a first method for triggering/initiating delay-aware buffer status reporting according to an embodiment of the disclosure. Various modifications may be made to the method illustrated in the flowcharts of FIG. 1. For example, although shown as a series of operations, various operations in each figure may overlap, occur in parallel, occur in a different order, or occur multiple times. In other examples, operations may be omitted or replaced with other operations.

Referring FIG. 1, the UE is configured/allowed to transmit delay-aware buffer status by gNB via RRCReconfiguration message (i.e. higher layer signaling) (101). The UE determines/identifies that delay aware buffer status is triggered (103).

In the first method of the disclosure, new MAC CE or the delay aware buffer status MAC CE of MAC CE including the delay knowledge of buffered data e.g. remaining time and distinguishing how much data is buffered for which delay is triggered by UE/ MAC entity when regular BSR is triggered.

Delay-aware buffer status (new MAC CE or the delay aware buffer status MAC CE or MAC CE including the delay knowledge of buffered data e.g. remaining time and distinguishing how much data is buffered for which delay) shall be triggered if any of the following events (105, 107, 109) occur for activated cell group (103):
Event 1 (105): UL data, for a logical channel which belongs to an LCG, becomes available to the MAC entity; and either
this UL data belongs to a logical channel with higher priority than the priority of any logical channel containing available UL data which belong to any LCG; or
none of the logical channels which belong to an LCG contains any available UL data.
Event 2 (107): retxBSR-Timer expires, and at least one of the logical channels which belong to an LCG contains UL data;
Event 3 (109): periodicBSR-Timer expires

In an alternate embodiment of this method of disclosure, delay-aware buffer status (new MAC CE or the delay aware buffer status MAC CE or MAC CE including the delay knowledge of buffered data e.g. remaining time and distinguishing how much data is buffered for which delay) shall be triggered if any of the following events occur for activated cell group (103):
Event 1: UL data, for a logical channel which belongs to an LCG for which delay-aware buffer status is configured, becomes available to the MAC entity; and either
this UL data belongs to a logical channel with higher priority than the priority of any logical channel containing available UL data which belong to any LCG for which delay-aware buffer status is configured; or
none of the logical channels which belong to an LCG for which delay-aware buffer status is configured contains any available UL data.
Event 2: retxBSR-Timer expires, and at least one of the logical channels which belong to an LCG for which delay-aware buffer status is configured contains UL data;
Event 3: periodicBSR-Timer expires

Network (i.e. gNB) may indicate for which one or more LCGs delay-aware buffer status is configured using RRCReconfiguration message.

In an alternate embodiment of this method of disclosure, delay-aware buffer status (new MAC CE or the delay aware buffer status MAC CE or MAC CE including the delay knowledge of buffered data e.g. remaining time and distinguishing how much data is buffered for which delay) shall be triggered if any of the following events occur for activated cell group (103):
Event 1: UL data, for a logical channel for which delay-aware buffer status is configured which belongs to an LCG, becomes available to the MAC entity; and either
this UL data belongs to a logical channel with higher priority than the priority of any logical channel (for which delay-aware buffer status is configured) containing available UL data which belong to any LCG; or
none of the logical channels for which delay-aware buffer status is configured which belong to an LCG any available UL data.
Event 2: retxBSR-Timer expires, and at least one of the logical channels for which delay-aware buffer status is configured which belong to an LCG contains UL data;
Event 3: periodicBSR-Timer expires

Network (i.e. gNB) may indicate for which one or more LCHs delay-aware buffer status is configured using RRCReconfiguration message.

In an alternate embodiment of this method of disclosure, delay-aware buffer status (new MAC CE or the delay aware buffer status MAC CE or MAC CE including the delay knowledge of buffered data e.g. remaining time and distinguishing how much data is buffered for which delay) shall be triggered if any of the following events occur for activated cell group (103):
Event 1: UL data, for a logical channel (for which delay-aware buffer status is configured) which belongs to an LCG for which delay-aware buffer status is configured, becomes available to the MAC entity; and either
this UL data belongs to a logical channel with higher priority than the priority of any logical channel (for which delay-aware buffer status is configured) containing available UL data which belong to any LCG (for which delay-aware buffer status is configured); or
none of the logical channels which belong to an LCG (for which delay-aware buffer status is configured) contains any available UL data.
Event 2: retxBSR-Timer expires, and at least one of the logical channels (for which delay-aware buffer status is configured) which belong to an LCG for which delay-aware buffer status is configured contains UL data;
Event 3: periodicBSR-Timer expires

### Method 2

According to an embodiment of the disclosure, a UE is configured/allowed to transmit delay-aware buffer status by gNB using RRCReconfiguration message (i.e. higher layer signaling). The UE may indicate its capability to support delay aware buffer status to gNB using UE capability information message.

FIG. 2 illustrates an example method performed by a UE according to an embodiment of the disclosure. FIG. 2 illustrates a second method for triggering/ initiating delay-aware buffer status reporting according to an embodiment of the disclosure. Various modifications may be made to the method illustrated in the flowcharts of FIG. 2. For example, although shown as a series of operations, various operations in each figure may overlap, occur in parallel, occur in a different order, or occur multiple times. In other examples, operations may be omitted or replaced with other operations.

Referring FIG. 2, the UE is configured/allowed to transmit delay-aware buffer status by gNB via RRCReconfiguration message (i.e. higher layer signaling) (201). The UE determines/identifies that delay aware buffer status is triggered (203). Delay aware buffer status shall be triggered if the following condition is satisfied (203).

In the second method of the disclosure (205), delay-aware buffer status (new MAC CE or the delay aware buffer status MAC CE or MAC CE including the delay knowledge of buffered data e.g. remaining time and distinguishing how much data is buffered for which delay) shall be triggered if for activated cell group:
regular BSR is triggered;

and
there is at least one LCH/LCG for which UE has non zero delay aware buffer size to be reported (which the UE has not yet reported or is different from what UE has reported previously).

In an alternate embodiment of this method, delay-aware buffer status (new MAC CE or the delay aware buffer status MAC CE or MAC CE including the delay knowledge of buffered data e.g. remaining time and distinguishing how much data is buffered for which delay) shall be triggered if for activated cell group:
regular BSR is triggered;

and
there is at least one LCH/LCG for which UE has non zero delay aware buffer size to be reported (which the UE has not yet reported or is different from what UE has reported previously);

and
the priority of the LCG/LCH is higher than priority of any LCG/LCH containing available UL data or for which the UE has non-zero delay aware buffer size to be reported.

### Method 3

According to an embodiment of the disclosure, a UE is configured/allowed to transmit delay-aware buffer status by gNB using RRCReconfiguration message (i.e. higher layer signaling). The UE may indicate its capability to support delay aware buffer status to gNB using UE capability information message.

FIG. 3 illustrates an example method performed by a UE according to an embodiment of the disclosure. FIG. 3 illustrates a third method for triggering/initiating delay-aware buffer status reporting according to an embodiment of the disclosure. Various modifications may be made to the method illustrated in the flowcharts of FIG. 3. For example, although shown as a series of operations, various operations in each figure may overlap, occur in parallel, occur in a different order, or occur multiple times. In other examples, operations may be omitted or replaced with other operations.

Referring FIG. 3, the UE is configured/allowed to transmit delay-aware buffer status by gNB via RRCReconfiguration message (i.e. higher layer signaling) (301). The UE is configured with periodicDelay AwareBSR-Timer (303). PeriodicDe-layAwareBSR-Timer is started upon configuration or upon indication (via MAC CE or DCI) from gNB (305). Upon expiry of periodicDelay AwareBSR-Timer, delay-aware buffer status (new MAC CE or the delay aware buffer status MAC CE or MAC CE including the delay knowledge of buffered data e.g. remaining time and distinguishing how much data is buffered for which delay) is triggered (307).

In the third method of the disclosure, delay-aware buffer status (new MAC CE or the delay aware buffer status MAC CE or MAC CE including the delay knowledge of buffered data e.g. remaining time and distinguishing how much data is buffered for which delay) shall be triggered if for activated cell group, periodicDelay AwareBSR-Timer expires (307).

PeriodicDelay AwareBSR-Timer is configured by gNB to UE using RRCReconfiguration message (303). This timer is configured per cell group. In an alternate embodiment, this timer may be configured per BWP. PeriodicDelay AwareBSR-Timer may be started upon configuration or upon indication (via MAC CE or DCI from gNB (305). Alternately the timer may be started when regular BSR is triggered or when UE starts onDuration timer.

### Method 4

According to an embodiment of the disclosure, a UE is configured/allowed to transmit delay-aware buffer status by gNB using RRCReconfiguration message (i.e. higher layer signaling). The UE may indicate its capability to support delay aware buffer status to gNB using UE capability information message.

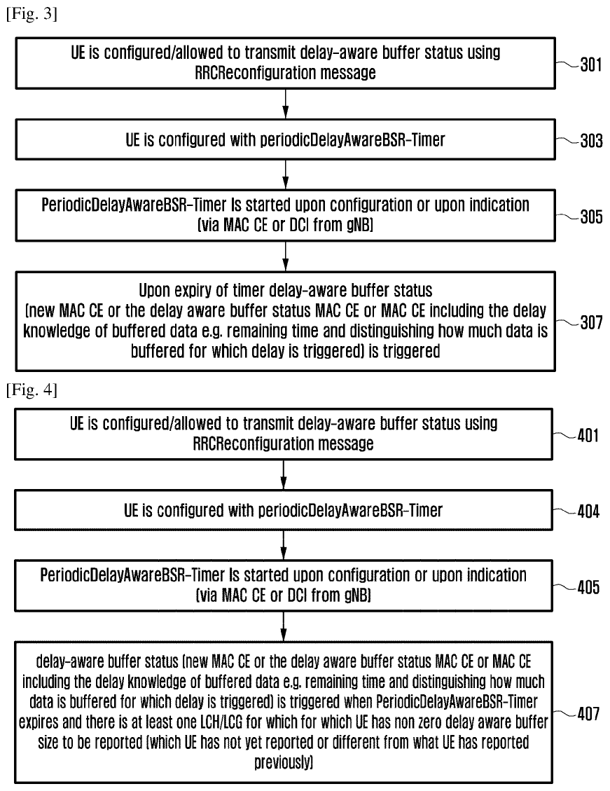

FIG. 4 illustrates an example method performed by a UE according to an embodiment of the disclosure. FIG. 4 illustrates a fourth method for triggering/initiating delay-aware buffer status reporting according to an embodiment of the disclosure. Various modifications may be made to the method illustrated in the flowcharts of FIG. 4. For example, although shown as a series of operations, various operations in each figure may overlap, occur in parallel, occur in a different order, or occur multiple times. In other examples, operations may be omitted or replaced with other operations.

Referring FIG. 4, the UE is configured/allowed to transmit delay-aware buffer status by gNB via RRCReconfiguration message (i.e. higher layer signaling) (401). The UE is configured with periodicDelay AwareBSR-Timer (403). PeriodicDe-layAwareBSR-Timer is started upon configuration or upon indication (via MAC CE or DCI) from gNB (405). Delay-aware buffer status (new MAC CE or the delay aware buffer status MAC CE or MAC CE including the delay knowledge of buffered data e.g. remaining time and distinguishing how much data is buffered for which delay) is triggered when periodicDelay AwareBSR-Timer expires and there is at least one LCH/ LCG for which for the UE has non zero delay aware buffer size to be reported (which the UE has not yet reported or different from what the UE has reported previously) (407).

In the fourth method of the disclosure (407), delay-aware buffer status (new MAC CE or the delay aware buffer status MAC CE or MAC CE including the delay knowledge of buffered data e.g. remaining time and distinguishing how much data is buffered for which delay) shall be triggered if for activated cell group,
periodicDelay AwareBSR-Timer expires; and
there is at least one LCH/LCG for which a UE has non zero delay aware buffer size to be reported (which the UE has not yet reported or different from what the UE has reported previously)

PeriodicDelay AwareBSR-Timer is configured by gNB to UE using RRCReconfiguration message (405). This timer is configured per cell group. In an alternate embodiment, this timer may be configured per BWP. PeriodicDelay AwareBSR-Timer may be started upon configuration or upon indication (via MAC CE or DCI from gNB. Alternately the timer may be started when regular BSR is triggered or when UE starts onDuration timer.

In an alternate embodiment of the method of disclosure, delay-aware buffer status (new MAC CE or the delay aware buffer status MAC CE or MAC CE including the delay knowledge of buffered data e.g. remaining time and distinguishing how much data is buffered for which delay is triggered) shall be triggered if for activated cell group,
periodicDelay AwareBSR-Timer expires; and
there is at least one LCH/LCG for which a UE has non zero delay aware buffer size to be reported (which the UE has not yet reported or different from what the UE has reported previously); and
the priority of the LCG/LCH is higher than priority of any LCG/LCH containing available UL data or for which UE has non-zero delay aware buffer size to be reported

### Method 5

According to an embodiment of the disclosure, a UE is configured/allowed to transmit delay-aware buffer status by gNB using RRCReconfiguration message (i.e. higher layer signaling). The UE may indicate its capability to support delay aware buffer status to gNB using UE capability information message.

In a fifth method of the disclosure, delay-aware buffer status (new MAC CE or the delay aware buffer status MAC CE or MAC CE including the delay knowledge of buffered data e.g. remaining time and distinguishing how much data is buffered for which delay) shall be triggered when,
there is at least one LCH/LCG for which a UE has non zero delay aware buffer size to be reported (which the UE has not yet reported or different from what the UE has reported previously)

In an alternate embodiment of the method of disclosure, delay-aware buffer status (new MAC CE or the delay aware buffer status MAC CE or MAC CE including the delay knowledge of buffered data e.g. remaining time and distinguishing how much data is buffered for which delay) shall be triggered when,
there is at least one LCH/LCG for which a UE has non zero delay aware buffer size to be reported (which the UE has not yet reported or different from what the UE has reported previously); and
the priority of the LCG/LCH is higher than priority of any LCG/LCH containing available UL data or for which UE has non-zero delay aware buffer size to be reported

### Method 6

According to an embodiment of the disclosure, a UE is configured/allowed to transmit delay-aware buffer status by gNB using RRCReconfiguration message (i.e. higher layer signaling). The UE may indicate its capability to support delay aware buffer status to gNB using UE capability information message.

In a sixth method of the disclosure, delay-aware buffer status (new MAC CE or the delay aware buffer status MAC CE or MAC CE including the delay knowledge of buffered data e.g. remaining time and distinguishing how much data is buffered for which delay) shall be triggered as follows,
Delay-aware buffer status shall be triggered when MAC entity starts OnDuration Timer

In an alternate embodiment of this method of disclosure, delay-aware buffer status (new MAC CE or the delay aware buffer status MAC CE or MAC CE including the delay knowledge of buffered data e.g. remaining time and distinguishing how much data is buffered for which delay) shall be triggered when,
MAC entity starts OnDuration Timer; and
there is at least one LCH/LCG which a UE has non zero delay aware buffer size to be reported (which the UE has not yet reported or different from what the UE has reported previously);

In an alternate embodiment of the method of disclosure, delay-aware buffer status (new MAC CE or the delay aware buffer status MAC CE or MAC CE including the delay knowledge of buffered data e.g. remaining time and distinguishing how much data is buffered for which delay) shall be triggered when,
MAC entity starts OnDuration Timer; and
there is at least one LCH/LCG for which UE has non zero delay aware buffer size to be reported (which the UE has not yet reported or different from what the UE has reported previously); and
the priority of the LCG/LCH is higher than priority of any LCG/LCH containing available UL data or for which UE has non-zero delay aware buffer size to be reported

### Method 7

According to an embodiment of the disclosure, a UE is configured/allowed to transmit delay-aware buffer status by gNB using RRCReconfiguration message (i.e. higher layer signaling). The UE may indicate its capability to support delay aware buffer status to gNB using UE capability information message.

In a seventh method of this disclosure, delay-aware buffer status (new MAC CE or the delay aware buffer status MAC CE or MAC CE including the delay knowledge of buffered data e.g. remaining time and distinguishing how much data is buffered for which delay) shall be triggered when requested by gNB. The gNB may send request via MAC CE or DCI or RRC message.

In an alternate embodiment, delay-aware buffer status may be triggered when Packet Data Convegence Protocol(PDCP)/Radio Link Control(RLC)/MAC Service Data Units(SDUs) are discarded.

In an alternate embodiment, delay-aware buffer status may be triggered when UL resources are allocated and the number of padding bits is equal to or larger than the size of the Delay aware buffer status MAC CE plus its subheader. This may be referred as ‘Delay Aware Padding BSR. The delay-aware buffer size fields may be filled up to the number of padding bits in descending order of priority of LCG/LCH having non-zero delay-aware buffer size

Another issue for XR is for UE to determine when MAC entity/UE cancel transmission of the delay-aware buffer status MAC CE i.e. MAC CE which includes delay knowledge of buffered data e.g. remaining time and distinguishing how much data is buffered for which delay.

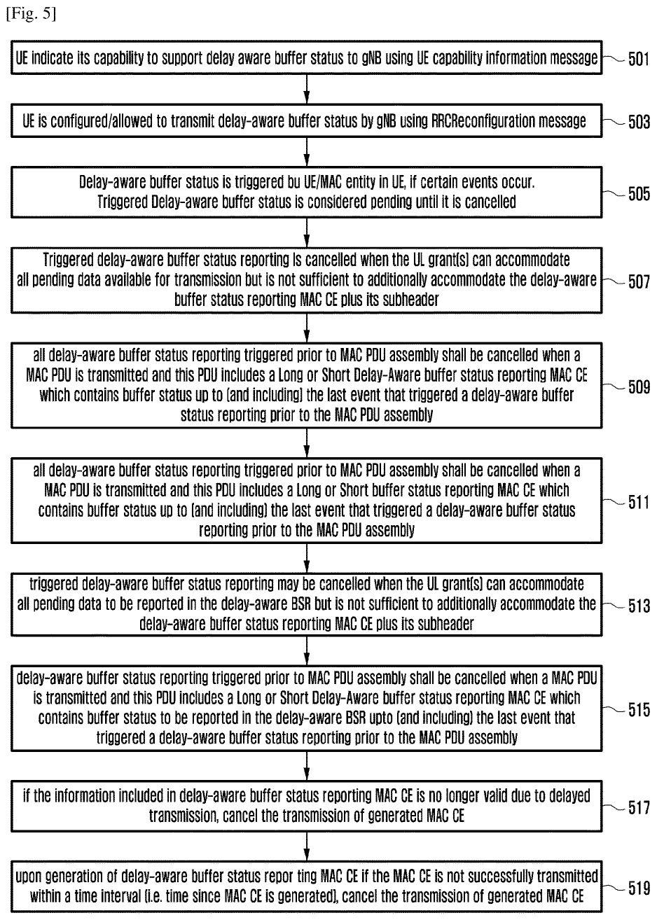

FIG. 5 illustrates an example method performed by a UE according to an embodiment of the disclosure. FIG. 5 illustrates a method for cancelling (triggered) delay-aware buffer status reporting according to an embodiment of the disclosure. Various modifications may be made to the method illustrated in the flowcharts of FIG. 5. For example, although shown as a series of operations, various operations in each figure may overlap, occur in parallel, occur in a different order, or occur multiple times. In other examples, operations may be omitted or replaced with other operations.

Referring FIG. 5, a UE is configured/allowed to transmit delay-aware buffer status by gNB using RRCReconfiguration message (i.e. higher layer signaling). The UE may indicate its capability to support delay aware buffer status to gNB using UE capability information message (501, 503).

Delay-aware buffer status (new MAC CE or the delay aware buffer status MAC CE or MAC CE including the delay knowledge of buffered data e.g. remaining time and distinguishing how much data is buffered for which delay is triggered) shall be triggered by the UE/MAC entity in UE, if certain events occur. Triggered Delay-aware buffer status is considered as pending until it is cancelled (505).

Triggered delay-aware buffer status reporting shall be cancelled if at least one of the following events/conditions (507, 509, 511, 513, 515, 517, 519) occurs.

In a method of the disclosure (507), all triggered delay-aware buffer status reporting may be cancelled when the UL grant(s) can accommodate all pending data available for transmission but is not sufficient to additionally accommodate the delay-aware buffer status reporting MAC CE plus its subheader.

In another method of the disclosure (509), all delay-aware buffer status reporting triggered prior to MAC PDU assembly shall be cancelled when a MAC PDU is transmitted and this PDU includes a Long or Short Delay-Aware buffer status reporting MAC CE which contains buffer status up to (and including) the last event that triggered a delay-aware buffer status reporting prior to the MAC PDU assembly.

In another method of the disclosure (511), all delay-aware buffer status reporting triggered prior to MAC PDU assembly shall be cancelled when a MAC PDU is transmitted and this PDU includes a Long or Short buffer status reporting MAC CE which contains buffer status up to (and including) the last event that triggered a delay-aware buffer status reporting prior to the MAC PDU assembly.

In another method of the disclosure (513), all triggered delay-aware buffer status reporting may be cancelled when the UL grant(s) can accommodate all pending data to be reported in the delay-aware BSR but is not sufficient to additionally accommodate the delay-aware buffer status reporting MAC CE plus its subheader.

In another method of the disclosure (515), all delay-aware buffer status reporting triggered prior to MAC PDU assembly shall be cancelled when a MAC PDU is transmitted and this PDU includes a Long or Short Delay-Aware buffer status reporting MAC CE which contains buffer status to be reported in the delay-aware BSR up to (and including) the last event that triggered a delay-aware buffer status reporting prior to the MAC PDU assembly.

In another method of the disclosure (517), if the information included in delay-aware buffer status reporting MAC CE is no longer valid due to delayed transmission,
A UE may cancel the transmission of generated MAC CE. If there is non-zero delay-aware buffer status for at least a logical channel, the UE may (re-)construct a delay-aware buffer status report.
Note that MAC PDU Prioritization, listen before talk (LBT) failures, hybrid automatic and repeat request (HARQ) failures, etc. may delay transmission. Also it is possible the MAC CE is included in MsgA/Msg3 (message A, message 3) of RA which may further delay. Additionally delay-aware buffer status may not be valid if the SDUs whose size is included in buffer size calculation are discarded

In another method of the disclosure (519), upon generation of delay-aware buffer status reporting MAC CE if the MAC CE is not successfully transmitted within a time interval (i.e. time since MAC CE is generated),
A UE may cancel the transmission of generated MAC CE
The value of timer interval or timer may be signaled by network (e.g. gNB) in system information (SI) or RRC message

Delay-aware buffer status reporting may include time sensitive information. In order for gNB to accurately estimate the timing gap between generation of delay-aware buffer status reporting MAC CE at UE and processing of this MAC CE at gNB, in one method of this disclosure, reference time (e.g. the time when this MAC CE is generated) may be included in delay-aware buffer status reporting MAC CE. Reference time may be system frame umber (SFN) and/or Subframe number and/or slot #. Reference time may be few least significant bits (LSBs) of Coordinated Universal Time (UTC) time (or UTC counter or time counter). In a method, (Shortest) remaining delivery time per LCH/LCG may be reported along with the reference time indicating the moment when the remaining delivery time is calculated.

If reference time is T1, Remaining delivery time in MAC CE is X, time when MAC CE is received/processed by gNB is T2, then
Actual remaining delivery time=R=X−(T2−T1). gNB uses this value to determine the time to schedule UL grant to UE.

Examples of events which may trigger Delay-aware buffer status are described below. For more specific details of the events, reference may be made to the description of the embodiment of the disclosure described above.

1. Delay-aware buffer status (new MAC CE or the delay aware buffer status MAC CE or MAC CE including the delay knowledge of buffered data e.g. remaining time and distinguishing how much data is buffered for which delay is triggered) shall be triggered if any of the following events occur for activated cell group:
Event 1: UL data, for a logical channel which belongs to an LCG, becomes available to the MAC entity; and either
this UL data belongs to a logical channel with higher priority than the priority of any logical channel containing available UL data which belong to any LCG; or
none of the logical channels which belong to an LCG contains any available UL data.
Event 2: retxBSR-Timer expires, and at least one of the logical channels which belong to an LCG contains UL data;
Event 3: periodicBSR-Timer expires

2. Delay-aware buffer status (new MAC CE or the delay aware buffer status MAC CE or MAC CE including the delay knowledge of buffered data e.g. remaining time and distinguishing how much data is buffered for which delay is triggered) shall be triggered if any of the following events occur for activated cell group:
Event 1: UL data, for a logical channel which belongs to an LCG for which delay-aware buffer status is configured, becomes available to the MAC entity; and either
this UL data belongs to a logical channel with higher priority than the priority of any logical channel containing available UL data which belong to any LCG for which delay-aware buffer status is configured; or
none of the logical channels which belong to an LCG for which delay-aware buffer status is configured contains any available UL data.
Event 2: retxBSR-Timer expires, and at least one of the logical channels which belong to an LCG for which delay-aware buffer status is configured contains UL data;
Event 3: periodicBSR-Timer expires Network (i.e. gNB) may indicate for which one or more LCGs delay-aware buffer status is configured using RRCReconfiguration message.

3. Delay-aware buffer status (new MAC CE or the delay aware buffer status MAC CE or MAC CE including the delay knowledge of buffered data e.g. remaining time and distinguishing how much data is buffered for which delay is triggered) shall be triggered if any of the following events occur for activated cell group:
Event 1: UL data, for a logical channel for which delay-aware buffer status is configured which belongs to an LCG, becomes available to the MAC entity; and either
this UL data belongs to a logical channel with higher priority than the priority of any logical channel (for which delay-aware buffer status is configured) containing available UL data which belong to any LCG; or
none of the logical channels for which delay-aware buffer status is configured which belong to an LCG any available UL data.
Event 2: retxBSR-Timer expires, and at least one of the logical channels for which delay-aware buffer status is configured which belong to an LCG contains UL data;
Event 3: periodicBSR-Timer expires

Network (i.e. gNB) may indicate for which one or more LCHs delay-aware buffer status is configured using RRCReconfiguration message.

4. Delay-aware buffer status (new MAC CE or the delay aware buffer status MAC CE or MAC CE including the delay knowledge of buffered data e.g. remaining time and distinguishing how much data is buffered for which delay is triggered) shall be triggered if any of the following events occur for activated cell group:
Event 1: UL data, for a logical channel (for which delay-aware buffer status is configured) which belongs to an LCG for which delay-aware buffer status is configured, becomes available to the MAC entity; and either
this UL data belongs to a logical channel with higher priority than the priority of any logical channel (for which delay-aware buffer status is configured) containing available UL data which belong to any LCG (for which delay-aware buffer status is configured); or
none of the logical channels which belong to an LCG (for which delay-aware buffer status is configured) contains any available UL data.
Event 2: retxBSR-Timer expires, and at least one of the logical channels (for which delay-aware buffer status is configured) which belong to an LCG for which delay-aware buffer status is configured contains UL data;
Event 3: periodicBSR-Timer expires

5. Delay-aware buffer status (new MAC CE or the delay aware buffer status MAC CE or MAC CE including the delay knowledge of buffered data e.g. remaining time and distinguishing how much data is buffered for which delay is triggered) shall be triggered if for activated cell group:
regular BSR is triggered;

and
there is at least one LCH/LCG for which UE has non zero delay aware buffer size to be reported (which UE has not yet reported or is different from what UE has reported previously).

6. Delay-aware buffer status (new MAC CE or the delay aware buffer status MAC CE or MAC CE including the delay knowledge of buffered data e.g. remaining time and distinguishing how much data is buffered for which delay is triggered) shall be triggered if for activated cell group:
regular BSR is triggered; and
there is at least one LCH/LCG for which UE has non zero delay aware buffer size to be reported (which UE has not yet reported or is different from what UE has reported previously);

and
the priority of the LCG/LCH is higher than priority of any LCG/LCH containing available UL data or for which UE has non-zero delay aware buffer size to be reported.

7. Delay-aware buffer status (new MAC CE or the delay aware buffer status MAC CE or MAC CE including the delay knowledge of buffered data e.g. remaining time and distinguishing how much data is buffered for which delay is triggered) shall be triggered if for activated cell group, periodicDelay AwareBSR-Timer expires. PeriodicDelay AwareBSR-Timer is configured by gNB to UE using RRCReconfiguration message. This timer is configured per cell group. In an alternate embodiment, this timer may be configured per BWP. PeriodicDelay AwareBSR-Timer may be started upon configuration or upon indication (via MAC CE or DCI from gNB. Alternately the timer may be started when regular BSR is triggered or when UE starts onDuration timer.

8. Delay-aware buffer status (new MAC CE or the delay aware buffer status MAC CE or MAC CE including the delay knowledge of buffered data e.g. remaining time and distinguishing how much data is buffered for which delay is triggered) shall be triggered if for activated cell group,
periodicDelay AwareBSR-Timer expires; and
there is at least one LCH/LCG for which a UE has non zero delay aware buffer size to be reported (which the UE has not yet reported or different from what the UE has reported previously)

9. Delay-aware buffer status (new MAC CE or the delay aware buffer status MAC CE or MAC CE including the delay knowledge of buffered data e.g. remaining time and distinguishing how much data is buffered for which delay is triggered) shall be triggered if for activated cell group,
periodicDelay AwareBSR-Timer expires; and
there is at least one LCH/LCG for which a UE has non zero delay aware buffer size to be reported (which the UE has not yet reported or different from what the UE has reported previously); and
the priority of the LCG/LCH is higher than priority of any LCG/LCH containing available UL data or for which UE has non-zero delay aware buffer size to be reported

10. Delay-aware buffer status (new MAC CE or the delay aware buffer status MAC CE or MAC CE including the delay knowledge of buffered data e.g. remaining time and distinguishing how much data is buffered for which delay is triggered) shall be triggered when,
there is at least one LCH/LCG for which a UE has non zero delay aware buffer size to be reported (which the UE has not yet reported or different from what the UE has reported previously)

11. Delay-aware buffer status (new MAC CE or the delay aware buffer status MAC CE or MAC CE including the delay knowledge of buffered data e.g. remaining time and distinguishing how much data is buffered for which delay is triggered) shall be triggered when,
there is at least one LCH/LCG for which a UE has non zero delay aware buffer size to be reported (which the UE has not yet reported or different from what the UE has reported previously); and
the priority of the LCG/LCH is higher than priority of any LCG/LCH containing available UL data or for which UE has non-zero delay aware buffer size to be reported

12. Delay-aware buffer status (new MAC CE or the delay aware buffer status MAC CE or MAC CE including the delay knowledge of buffered data e.g. remaining time and distinguishing how much data is buffered for which delay is triggered) shall be triggered as follows,
Delay-aware buffer status shall be triggered when MAC entity starts OnDuration Timer

13. Delay-aware buffer status (new MAC CE or the delay aware buffer status MAC CE or MAC CE including the delay knowledge of buffered data e.g. remaining time and distinguishing how much data is buffered for which delay is triggered) shall be triggered when,
MAC entity starts OnDuration Timer; and
there is at least one LCH/LCG for which a UE has non zero delay aware buffer size to be reported (which the UE has not yet reported or different from what the UE has reported previously);

14. Delay-aware buffer status (new MAC CE or the delay aware buffer status MAC CE or MAC CE including the delay knowledge of buffered data e.g. remaining time and distinguishing how much data is buffered for which delay is triggered) shall be triggered when,
MAC entity starts OnDuration Timer; and
there is at least one LCH/LCG for which a UE has non zero delay aware buffer size to be reported (which the UE has not yet reported or different from what the UE has reported previously); and
the priority of the LCG/LCH is higher than priority of any LCG/LCH containing available UL data or for which UE has non-zero delay aware buffer size to be reported

15. Delay-aware buffer status (new MAC CE or the delay aware buffer status MAC CE or MAC CE including the delay knowledge of buffered data e.g. remaining time and distinguishing how much data is buffered for which delay is triggered) shall be triggered when requested by gNB. The gNB may send request via MAC CE or DCI or RRC message.

16. Delay-aware buffer status may be triggered when PDCP/RLC/MAC SDUs are discarded.

17. Delay-aware buffer status may be triggered when UL resources are allocated and number of padding bits is equal to or larger than the size of the Delay aware buffer status MAC CE plus its subheader. This may be referred as ‘Delay Aware Padding BSR. The delay-aware buffer size fields may be filled up to the number of padding bits in descending order of priority of LCG/LCH having non-zero delay-aware buffer size.

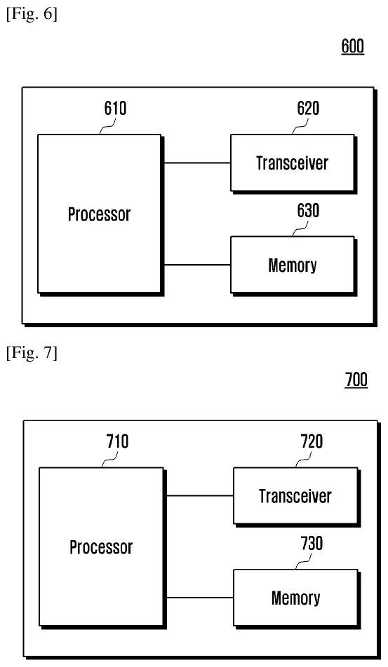

FIG. 6 illustrates an electronic device according to embodiments of the present disclosure.

Referring to the FIG. 6, the electronic device 600 may include a processor 610, a transceiver 620 and a memory 630. However, all of the illustrated components are not essential. The electronic device 600 may be implemented by more or less components than those illustrated in FIG. 6. In addition, the processor 610 and the transceiver 620 and the memory 630 may be implemented as a single chip according to another embodiment.

The electronic device 600 may correspond to the UE described above.

The aforementioned components will now be described in detail.

The processor 610 may include one or more processors or other processing devices that control the proposed function, process, and/or method. Operation of the electronic device 600 may be implemented by the processor 610.

The transceiver 620 may include a RF transmitter for up-converting and amplifying a transmitted signal, and a RF receiver for down-converting a frequency of a received signal. However, according to another embodiment, the transceiver 620 may be implemented by more or less components than those illustrated in components.

The transceiver 620 may be connected to the processor 610 and transmit and/or receive a signal. The signal may include control information and data. In addition, the transceiver 620 may receive the signal through a wireless channel and output the signal to the processor 610. The transceiver 620 may transmit a signal output from the processor 610 through the wireless channel.

The memory 630 may store the control information or the data included in a signal obtained by the electronic device 600. The memory 630 may be connected to the processor 510 and store at least one instruction or a protocol or a parameter for the proposed function, process, and/or method. The memory 630 may include read-only memory (ROM) and/or random access memory (RAM) and/or hard disk and/or CD-ROM and/or DVD and/or other storage devices.

FIG. 7 illustrates a base station according to embodiments of the present disclosure.

Referring to the FIG. 7, the base station 700 may include a processor 710, a transceiver 720 and a memory 730. However, all of the illustrated components are not essential. The base station 700 may be implemented by more or less components than those illustrated in FIG. 7. In addition, the processor 710 and the transceiver 720 and the memory 630 may be implemented as a single chip according to another embodiment.

The base station 700 may correspond to the gNB described above.

The aforementioned components will now be described in detail.

The processor 710 may include one or more processors or other processing devices that control the proposed function, process, and/or method. Operation of the base station 700 may be implemented by the processor 710.

The transceiver 720 may include a RF transmitter for up-converting and amplifying a transmitted signal, and a RF receiver for down-converting a frequency of a received signal. However, according to another embodiment, the transceiver 720 may be implemented by more or less components than those illustrated in components.

The transceiver 720 may be connected to the processor 710 and transmit and/or receive a signal. The signal may include control information and data. In addition, the transceiver 720 may receive the signal through a wireless channel and output the signal to the processor 610. The transceiver 720 may transmit a signal output from the processor 710 through the wireless channel.

The memory 730 may store the control information or the data included in a signal obtained by the base station 700. The memory 730 may be connected to the processor 710 and store at least one instruction or a protocol or a parameter for the proposed function, process, and/or method. The memory 730 may include read-only memory (ROM) and/or random access memory (RAM) and/or hard disk and/or CD-ROM and/ or DVD and/or other storage devices.

The methods according to various embodiments described in the claims or the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program may include instructions that cause the electronic device to perform the methods according to various embodiments of the disclosure as defined by the appended claims and/or disclosed herein.

The programs (software modules or software) may be stored n non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form a memory in which the program is stored. Further, a plurality of such memories may be included in the electronic device.

In addition, the programs may be stored in an attachable storage device which may access the electronic device through communication networks such as the Internet, Intranet, Local Area Network (LAN), Wide LAN (WLAN), and Storage Area Network (SAN) or a combination thereof. Such a storage device may access the electronic device via an external port. Further, a separate storage device on the communication network may access a portable electronic device.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

The embodiments of the disclosure described and shown in the specification and the drawings are merely specific examples that have been presented to easily explain the technical contents of the disclosure and help understanding of the disclosure, and are not intended to limit the scope of the disclosure. That is, it will be apparent to those skilled in the art that other variants based on the technical idea of the disclosure may be implemented. Furthermore, the above respective embodiments may be employed in combination, as necessary. For example, a part of one embodiment of the disclosure may be combined with a part of another embodiment to operate a base station and a terminal.

In the drawings in which methods of the disclosure are described, the order of the description does not always correspond to the order in which steps of each method are performed, and the order relationship between the steps may be changed or the steps may be performed in parallel.

Alternatively, in the drawings in which methods of the disclosure are described, some elements may be omitted and only some elements may be included therein without departing from the essential spirit and scope of the disclosure.

Any of the above variation embodiments can be utilized independently or in combination with at least one other variation embodiment. The above flowchart(s) illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

1. A method performed by a user equipment (UE) in a communication system, the method comprising:
receiving, from a base station, a radio resource control (RRC) message including configuration information on reporting of delay information associated with buffered data;
identifying that the reporting of delay information is triggered based on the configuration information; and
transmitting, to the base station, a medium access control (MAC) control element (CE) for the reporting of delay information in case that the reporting of delay information is pending,
wherein, in case that the reporting of delay information is triggered, the reporting of delay information is identified as pending until the reporting of delay information is cancelled.

2. The method of claim 1, wherein the reporting of delay information is triggered in case that a remaining time associated with the buffered data is lower than a threshold included in the configuration information.

3. The method of claim 2, wherein the MAC CE for the reporting of delay information includes information on the remaining time.

4. The method of claim 1, further comprising:
transmitting, to the base station, capability information including an indication whether the UE supports the reporting of delay information.

5. The method of claim 1, wherein the reporting of delay information is cancelled in case that all buffered data is transmitted.

6. The method of claim 1, wherein the reporting of delay information is cancelled in case that the MAC CE is transmitted and the MAC CE includes delay information associated with all buffered data.

7. The method of claim 1, wherein the buffered data is buffered for a logical channel group (LCG).

8. A user equipment (UE) in a communication system, the UE comprising:
a transceiver; and
a processor coupled with the transceiver and configured to:
receive, from a base station, a radio resource control (RRC) message including configuration information on reporting of delay information associated with buffered data;
identify that the reporting of delay information is triggered based on the configuration information; and
transmit, to the base station, a medium access control (MAC) control element (CE) for the reporting of delay information in case that the reporting of delay information is pending,
wherein, in case that the reporting of delay information is triggered, the reporting of delay information is identified as pending until the reporting of delay information is cancelled.

9. The UE of claim 8, wherein the reporting of delay information is triggered in case that a remaining time associated with the buffered data is lower than a threshold included in the configuration information.

10. The UE of claim 9, wherein the MAC CE for the reporting of delay information includes information on the remaining time.

11. The UE of claim 8, wherein the processor is further configured to:
transmit, to the base station, capability information including an indication whether the UE supports the reporting of delay information.

12. The UE of claim 8, wherein the reporting of delay information is cancelled in case that all buffered data is transmitted.

13. The UE of claim 8, wherein the reporting of delay information is cancelled in case that the MAC CE is transmitted and the MAC CE includes delay information associated with all buffered data.

14. A method performed by a base station in a communication system, the method comprising:
transmitting, to a user equipment (UE), a radio resource control (RRC) message including configuration information on reporting of delay information associated with buffered data; and
receiving, from the UE, a medium access control (MAC) control element (CE) for the reporting of delay information in case that the reporting of delay information is pending,
wherein, in case that the reporting of delay information is triggered, the reporting of delay information is identified as pending until the reporting of delay information is cancelled.

15. A base station in a communication system, the base station comprising:
a transceiver; and
a processor coupled with the transceiver and configured to:
transmit, to a user equipment (UE), a radio resource control (RRC) message including configuration information on reporting of delay information associated with buffered data; and
receive, from the UE, a medium access control (MAC) control element (CE) for the reporting of delay information in case that the reporting of delay information is pending,
wherein, in case that the reporting of delay information is triggered, the reporting of delay information is identified as pending until the reporting of delay information is cancelled.
